(19) United States
(12) Patent Application Publication
(10) Pub. No.: US 2007/0241608 A1
(43) Pub. Date: Oct. 18, 2007

(54) Bicycle hub and assembly of bicycle hub and spokes

(75) Inventor: Hubert Chen, Taichung Hsien (TW)

Correspondence Address: FOLEY AND LARDNER LLP;SUITE 500, 3000 K STREET NW, WASHINGTON, DC, 20007, US

(73) Assignee: Kun Teng Industry Co., Ltd.

(21) Appl. No.: 11/402,835

(22) Filed: Apr. 13, 2006

(51) Int. Cl. B60B 27/00

(52) U.S. Cl. 301/105.1

(57) ABSTRACT

A bicycle hub is adapted to be connected to a wheel rim by a plurality of spokes, each having-an insert portion to interconnect bent and head portions. The hub includes a hub shell rotatable about an axis, and an annular spoke mounting flange which extends radially from the hub shell, and which has a plurality of recesses, each extending from an outer radial surface of the flange axially to terminate at a recess base surface, and outwardly and radially to an outer peripheral surface, and a plurality of mounting holes extending from an inner radial surface to be communicated with the recess base surface. The head portion of each spoke abuts against one of the recess base surface and the inner radial surface so as to dispose the insert portion in the mounting hole. The bent portion and the head portion are confined in the corresponding recesses for protection purposes.

### BACKGROUND OF THE INVENTION

1. Field of the Invention

This invention relates to a bicycle hub, more particularly to a bicycle hub which is adapted to be connected to a wheel rim by a plurality of spokes, and an assembly of the bicycle hub and the spokes.

2. Description of the Related Art

Referring to FIG. 1, a conventional bicycle hub 1 is shown to be connected to a wheel rim (not shown) by a plurality of spokes 22,23. Each of the spokes 22,23 has an anchoring end 224,234, an enlarged head portion 221,231 opposite to the anchoring end 224,234, an insert portion 222,232 extending from the head portion 221,231, and a bent portion 223,233 extending from and bent relative to the insert portion 222,232. The hub 1 includes a hub shell 11 which rotatably surrounds a bicycle wheel axle 21, and annular first and second spoke mounting flanges 12,13 which extend from the hub shell 11 radially and outwardly and which are spaced apart from each other. Each of the spoke mounting flanges 12,13 has inner and outer radial surfaces 122,121;132,131 and a plurality of angularly displaced mounting holes 123,133 extending through the inner and outer radial surfaces 122,121;132,131 such that in assembly, the anchoring end 224,234 of the respective spoke 22,23 is led through the corresponding mounting hole 123,133 to have the head portion 221 abutting against one of the radial surfaces 122,121,132,131 so as to dispose the insert portion 222,232 in the mounting hole 123,133. The spokes 22,23 are arranged in a variety of manners according to different bicycle designs. For example, as shown in FIGS. 1 and 2, on the first spoke mounting flange 12, both the first and the second spokes 22,23 are mounted to have their head portions 221,231 abutting against the outer and inner radial surfaces 121,122, respectively. On the second spoke mounting flange 13, the first spokes 22 are mounted to have their head portions 221 abutting against the outer radial surface 131.

In use, the head portions 221 and the bent portions 233 are liable to contact an obstacle 10 to thereby result in wearing and breakage, especially when the hub 1 is used to rest on a step or a corner of a platform in an acrobatics performance.

### SUMMARY OF THE INVENTION

The object of the present invention is to provide a bicycle hub which is connected to a plurality of spokes and which can protect the spokes from coming into contact with an obstacle.

According to this invention, the bicycle hub is adapted to be connected to a wheel rim by a plurality of spokes. Each spoke has an anchoring end, an enlarged head portion opposite to the anchoring end, an insert portion extending from the head portion, and a bent portion extending from and bent relative to the insert portion to permit connection of the anchoring end to the wheel rim when the insert portion extends in an axial direction. The wheel hub includes a hub shell having an inner cylindrical wall surface rotatably surrounding an axis in the axial direction, and an outer cylindrical wall surface disposed opposite to the inner cylindrical wall surface in radial directions relative to the axis. An annular spoke mounting flange extends from an annular end region of the outer cylindrical wall surface in radial directions, and terminates at an outer peripheral surface. The spoke mounting flange has inner and outer radial surfaces opposite to each other in the axial direction, a plurality of recesses which are angularly displaced from one another about the axis, and each of which extends from the outer radial surface towards the inner radial surface to form a recess side surface and to terminate at a recess base surface, and further extends from the recess side surface outwardly and in a radial direction such that the recess base surface is communicated with the outer peripheral surface, and a plurality of mounting holes which are angularly displaced from one another about the axis, and each of which extends from the inner radial surface to be communicated with the recess base surface in a respective one of the recesses. Once the anchoring end is led through the respective mounting hole to have the head portion abutting against one of the inner radial surface and the recess base surface to thereby dispose the insert portion in the respective one of the mounting holes, one of the bent and head portions is confined in the respective recess without extending beyond the outer radial surface in the axial direction.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a fragmentary sectional view of a conventional assembly of a bicycle hub and spokes mounted on a bicycle wheel axle;

FIG. 2 is a side view of the conventional bicycle hub and spokes assembly;

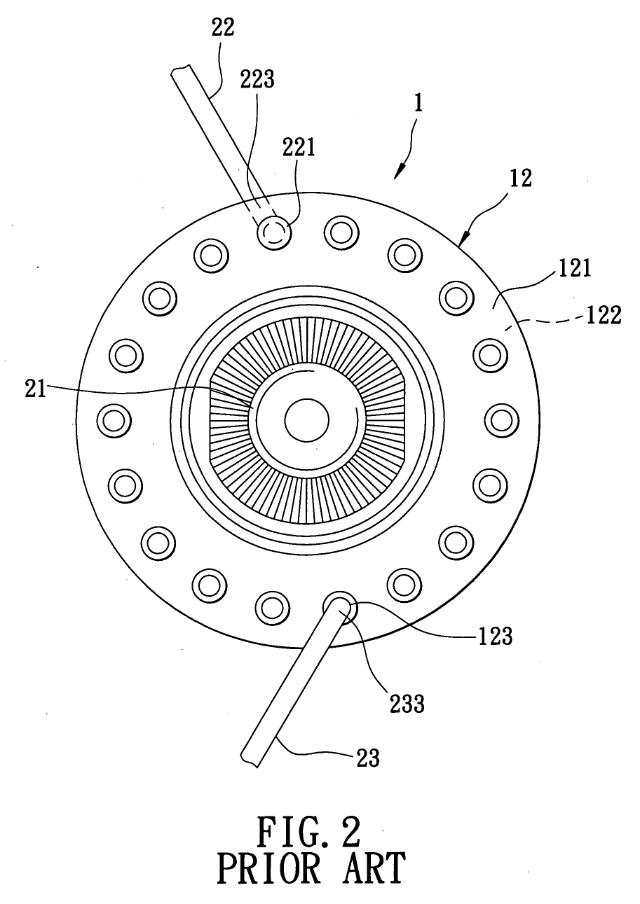

FIG. 3 is a fragmentary sectional view of the preferred embodiment of an assembly of a bicycle hub and spokes according to this invention; and

FIG. 4 is a side view of the preferred embodiment.

### DETAILED DESCRIPTION OF THE PREFERRED EMBODIMENT

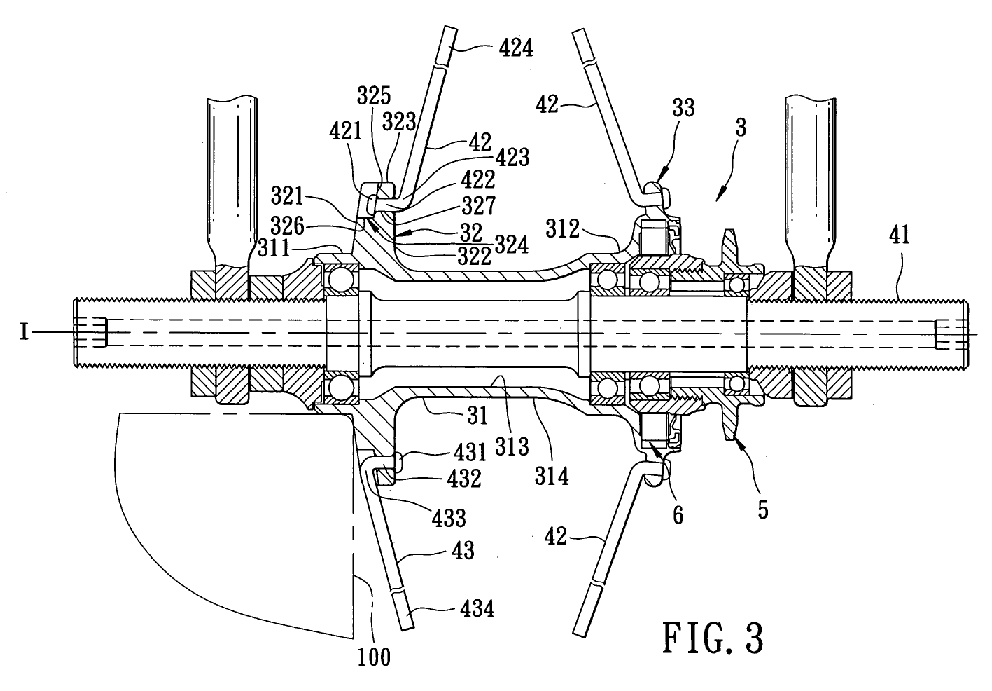

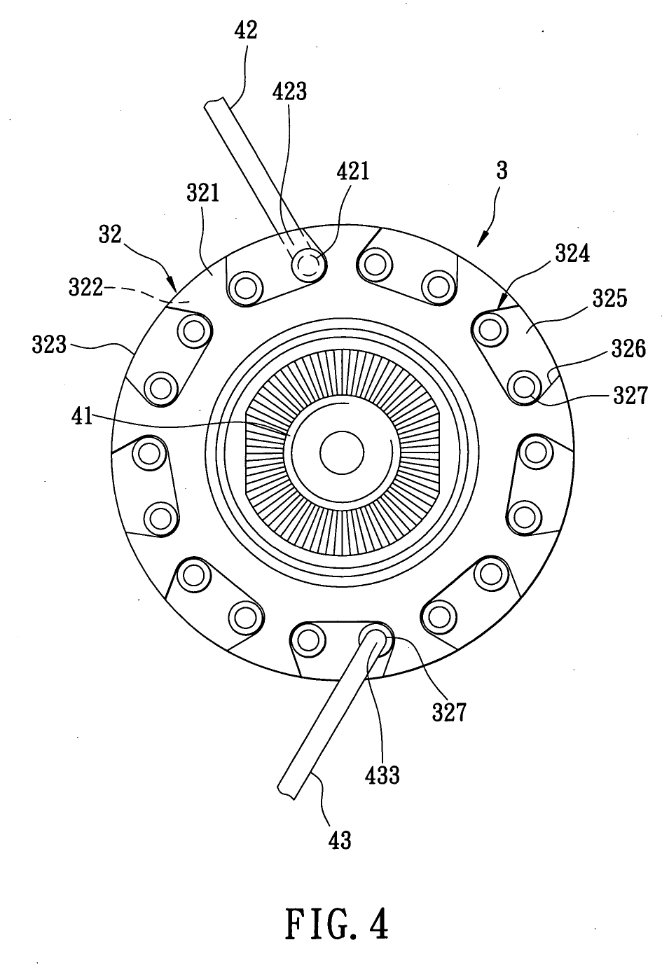

Referring to FIGS. 3 and 4, the preferred embodiment of an assembly of a bicycle hub and spokes according to the present invention is shown to comprise a bicycle hub 3 which is adapted to be connected to a wheel rim (not shown) by a plurality of spokes 42,43. Similar to the conventional spokes 22,23 described above, each of the spokes 42,43 has an anchoring end 424,434, an enlarged head portion 421,431 opposite to the anchoring end 424,434, an insert portion 422,432 extending from the head portion 421,431, and a bent portion 423,433 extending from and bent relative to the insert portion 422,432 to permit connection of the anchoring end 424,434 to the wheel rim when the insert portion 422,432 extends in an axial direction.

The wheel hub 3 includes a hub shell 31 and annular first and second spoke mounting flanges 32,33. In this embodiment, the wheel hub 3 is applied to a rear wheel of a bicycle (not shown) and is therefore used in combination with a sprocket 5 and a ratchet mechanism 6. The hub shell 31 has an inner cylindrical wall surface 313 which surrounds a bicycle wheel axle 41 to be rotatable about an axis (I) in the axial direction, and an outer cylindrical wall surface 314 which is disposed opposite to the inner cylindrical wall surface 313 in radial directions relative to the axis (I), and which has first and second annular end regions 311,312 that are disposed opposite to each other along the axis (I).

The first spoke mounting flange 32 extends from the first annular end region 311 in radial directions, and terminates at a first outer peripheral surface 323 that surrounds the axis (I). The first spoke mounting flange 32 has inner and outer radial surfaces 322,321 opposite to each other in the axial direction. The outer radial surface 321 extends in radial directions to interconnect the first annular end region 311 and the first outer peripheral surface 323. A plurality of recesses 324 are angularly displaced from one another about the axis (I). Each of the recesses 324 extends from the outer radial surface 321 towards the inner radial surface 322 to form a recess side surface 326 and to terminate at a recess base surface 325, and further extends from the recess side surfaces 326 outwardly and in a radial direction such that the recess base surface 325 is communicated with the first outer peripheral surface 323. A plurality of mounting holes 327 are angularly displaced from one another about the axis (I). Each of the mounting holes 327 extends from the inner radial surface 322 to be communicated with the recess base surface 325 in a respective one of the recesses 324. Thus, once the anchoring end 424,434 of the respective spoke 42,43 has been led through the respective mounting holes 327 to have the head portion 421,431 abutting against one of the recess base surface 325 and the inner radial surface 322 and to thereby locate the insert portion 422,432 in the respective mounting hole 327, one of the bent and head portions 421,433 is confined in the corresponding recess 324 without extending beyond the outer radial surface 321 in the axial direction.

In this embodiment, each of the recesses 324 is arranged to correspond to two adjacent mounting holes 327 such that a pair of the spokes 42,43 are mounted in the two adjacent mounting holes 327. Specifically, one spoke 43 has the head portion 431 abutting against the inner radial surface 322 and the insert portion 432 located in one of the mounting holes 327, while the other spoke 42 has the head portion 421 abutting against the recess base surface 325 and the insert portion 422 located in the other one of the mounting holes 327.

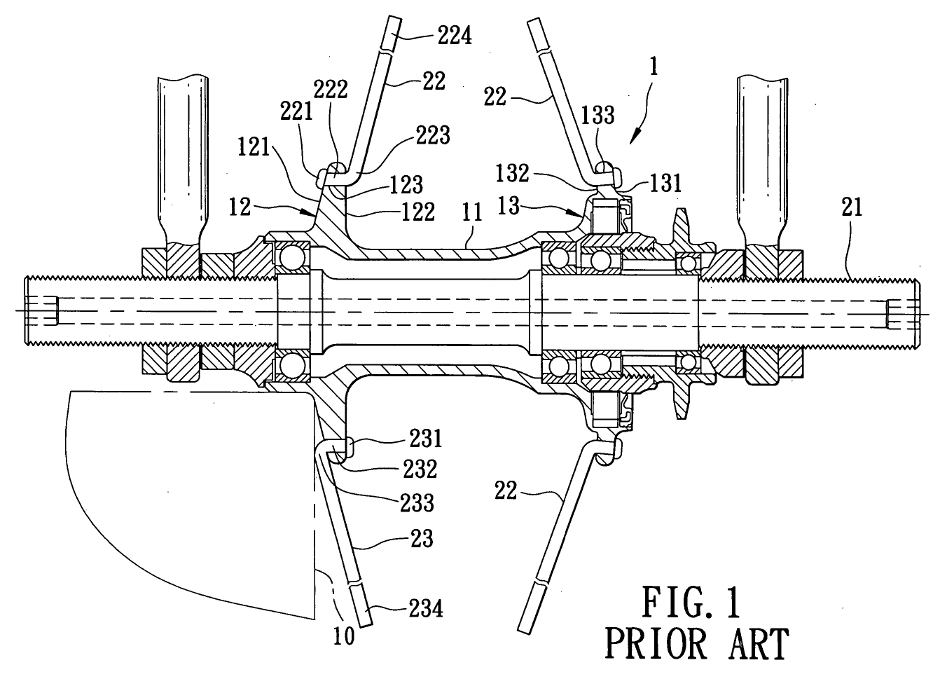

The second spoke mounting flange 33 extends from the second annular end region 312 in radial directions, and is spaced apart from the first spoke mounting flange 32 in the axial direction. In this embodiment, the second spoke mounting flange 33 has a construction similar to that of the conventional bicycle hub 1 shown in FIG. 1 for mounting the first spokes 42.

As illustrated, since the head portions 421 and the bent portions 433 which are disposed laterally and outwardly of the first spoke mounting flange 32 can be received in the corresponding recesses 324 without extending beyond the outer radial surface 321, contact of these portions 421,433 with an obstacle 100 (see FIG. 3) can be avoided, thereby guarding these portions 421,433 against breaking and wearing. It is noted that the second spoke mounting flange 33 may be the same as the first spoke mounting flange 32 in construction so as to enable the bicycle hub of this invention to be applied to the front wheel (not shown) of the bicycle.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A bicycle hub adapted to be connected to a wheel rim by a plurality of spokes, each of the spokes having an anchoring end, an enlarged head portion opposite to the anchoring end, an insert portion extending from the head portion, and a bent portion extending from and bent relative to the insert portion to permit connection of the anchoring end to the wheel rim when the insert portion extends in an axial direction, said wheel hub comprising:
a hub shell having an inner cylindrical wall surface which surrounds and which is rotatable about an axis in the axial direction, and an outer cylindrical wall surface which is disposed opposite to said inner cylindrical wall surface in radial directions relative to the axis, and which has first and second annular end regions that are disposed opposite to each other along the axis; and
an annular first spoke mounting flange which extends from said first annular end region in radial directions, and which terminates at a first outer peripheral surface that surrounds the axis, said first spoke mounting flange having
inner and outer radial surfaces opposite to each other in the axial direction, said outer radial surface extending in radial directions to interconnect said first annular end region and said first outer peripheral surface,
a plurality of recesses which are angularly displaced from one another about the axis, each of said recesses extending from said outer radial surface towards said inner radial surface to form a recess side surface and to terminate at a recess base surface, each of said recesses further extending from said recess side surface outwardly and in a radial direction such that said recess base surface is communicated with said first outer peripheral surface, and
a plurality of mounting holes which are angularly displaced from one another about the axis, and each of which extends from said inner radial surface to communicate with said recess base surface in a respective one of said recesses,
wherein once the anchoring end is led through a respective one of said mounting holes to have the head portion abutting against one of said inner radial surface and said recess base surface to thereby dispose the insert portion in the respective one of said mounting holes, one of the bent and head portions is confined in a respective one of said recesses without extending beyond said outer radial surface in the axial direction.

2. The bicycle hub of claim 1, wherein each of said recesses is arranged to correspond to two adjacent ones of said mounting holes such that when one of two adjacent ones of the spokes has the head portion abutting against said inner radial surface and the insert portion located in one of said two adjacent ones of said mounting holes, the other one of the two adjacent ones of the spokes has the head portion abutting against said recess base surface and the insert portion located in the other one of said two adjacent ones of said mounting holes.

3. The bicycle hub of claim 1, wherein an annular second spoke mounting flange extends from said second annular end region in radial directions, and which is spaced apart from said first spoke mounting flange in the axial direction.

4. An assembly of a bicycle hub and spokes adapted to be connected to a wheel rim, comprising:
a plurality of spokes, each of said spokes having an anchoring end, an enlarged head portion opposite to said anchoring end, an insert portion extending from said head portion, and a bent portion extending from and bent relative to said insert portion to permit connection of said anchoring end to the wheel rim when said insert portion extends in an axial direction;
a hub shell having an inner cylindrical wall surface which surrounds and which is rotatable about an axis in the axial direction, and an outer cylindrical wall surface which is disposed opposite to said inner cylindrical wall surface in radial directions relative to the axis, and which has first and second annular end regions that are disposed opposite to each other along the axis; and
an annular first spoke mounting flange which extends from said first annular end region in radial directions, and which terminates at a first outer peripheral surface that surrounds the axis, said first spoke mounting flange having
inner and outer radial surfaces opposite to each other in the axial direction, said outer radial surface extending in radial directions to interconnect said first annular end region and said first outer peripheral surface,
a plurality of recesses which are angularly displaced from one another about the axis, each of said recesses extending from said outer radial surface towards said inner radial surface to form a recess side surface and to terminate at a recess base surface, each of said recesses further extending from said recess side surface outwardly and in a radial direction such that said recess base surface is communicated with said first outer peripheral surface, and
a plurality of mounting holes which are angularly displaced from one another about the axis, and each of which extends from said inner radial surface to be communicated with said recess base surface in a respective one of said recesses,
wherein once said anchoring end is led through a respective one of said mounting holes to have said head portion abutting against one of said inner radial surface and said recess base surface to thereby dispose said insert portion in the respective one of said mounting holes, one of said bent and head portions is confined in a respective one of said recesses without extending beyond said outer radial surface in the axial direction.

5. The bicycle hub and spokes assembly of claim 1, wherein each of said recesses are arranged to correspond with two adjacent ones of said mounting holes such that when one of two adjacent ones of said spokes has said head portion abutting against said inner radial surface and said insert portion located in one of said two adjacent ones of said mounting holes, the other one of the two adjacent ones of said spokes has said head portion abutting against said recess base surface and said insert portion located in the other one of said two adjacent ones of said mounting holes.
